(19) United States
(12) Patent Application Publication
(10) Pub. No.: US 2022/0228529 A1
(43) Pub. Date: Jul. 21, 2022

(54) Air Powered Engine Assembly

(71) Applicant: Richard Schilson, Milan, IN (US)

(72) Inventor: Richard Schilson, Milan, IN (US)

(21) Appl. No.: 17/154,470

(22) Filed: Jan. 21, 2021

(51) Int. Cl. F02C 1/02; F03G 7/10

(52) U.S. Cl. CPC F02C 1/02; F03G 7/10; F05D 2220/70; F05D 2220/32; F05D 2210/12

(57) ABSTRACT

An air powered engine assembly for improving efficiency includes a housing, which has an axle rotationally engaged thereto and extending through a front and a rear thereof. A turbine and a cam are engaged to the axle and positioned within the housing proximate to the front and the rear, respectively. The cam is bilobal. A plate engaged to the housing defines a chamber therein. The plate has a plurality of apertures positioned therein. Each of a set of reciprocating compressors is engaged to the housing and is fluidically engaged to the chamber. The reciprocating compressor comprises a piston rotationally engaged to an arm, which is rotationally engaged the housing. The reciprocating compressor forces air through the apertures to turn the turbine to rotate the axle. The cam is rotated to selectively engage alternatingly positioned arms as the axle rotates to actuate associated reciprocating compressors.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to engine assemblies and more particularly pertains to a new engine assembly for improving efficiency. The present invention discloses an air powered engine assembly having a turbine and reciprocating compressors operationally engaged to an axle, such that rotation of the axle actuates the reciprocating compressors to generate air flow to power the turbine to rotate the axle.

### (2) Description of Related Art Including Information Disclosed Under 37 CFR 1.97 and 1.98

The prior art relates to engine assemblies. Prior art air powered engine assemblies may comprise engines utilizing compressed air as a power source. What is lacking in the prior art is an air powered engine assembly having a turbine and reciprocating compressors operationally engaged to an axle, such that rotation of the axle actuates the reciprocating compressors to generate air flow to power the turbine to rotate the axle.

### BRIEF SUMMARY OF THE INVENTION

An embodiment of the disclosure meets the needs presented above by generally comprising a housing, which defines an interior space. An axle is rotationally engaged to the housing and extends through a front and rear thereof. A turbine and a cam are engaged to the axle and positioned in the interior space proximate to the front and the rear of the housing, respectively. The cam is bilobal.

A plate is engaged to the housing and extends around an inner circumference thereof to define a chamber within the interior space. The plate has a plurality of apertures positioned therein. A set of reciprocating compressors is engaged to the housing. Each reciprocating compressor is fluidically engaged to the chamber and comprises a piston and an arm. The arm is rotationally engaged to the piston and the housing. The reciprocating compressor is positioned to force air through the apertures such that the air turns the turbine to rotate the axle. The cam is rotated to selectively engage alternatingly positioned arms as the axle rotates to actuate associated reciprocating compressors.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of an air powered engine assembly according to an embodiment of the disclosure.

FIG. 2 is a rear view of an embodiment of the disclosure.

FIG. 3 is a side view of an embodiment of the disclosure.

FIG. 4 is a detail view of an embodiment of the disclosure.

### DETAILED DESCRIPTION OF THE INVENTION

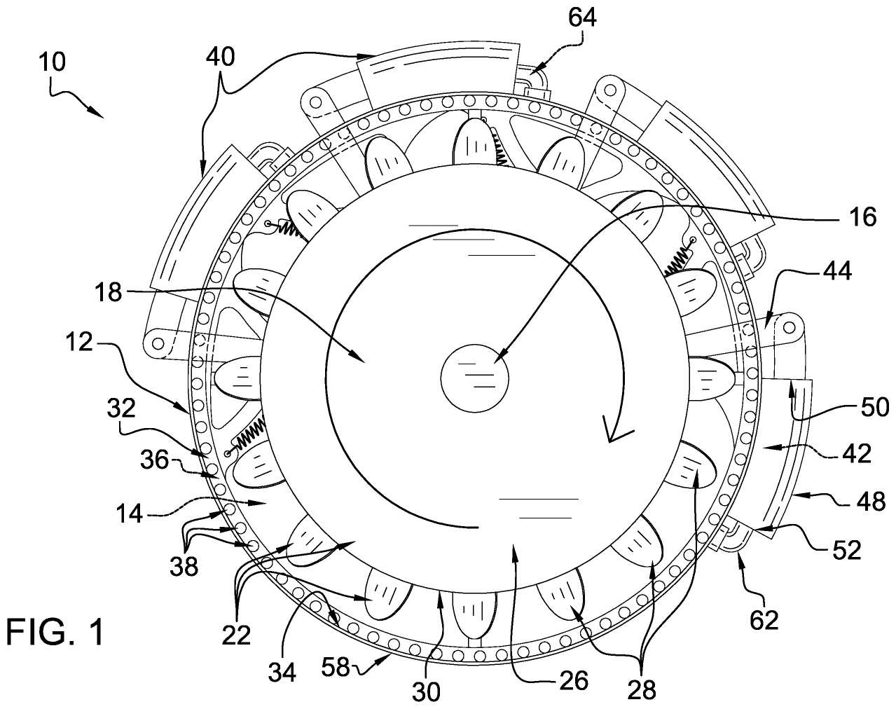

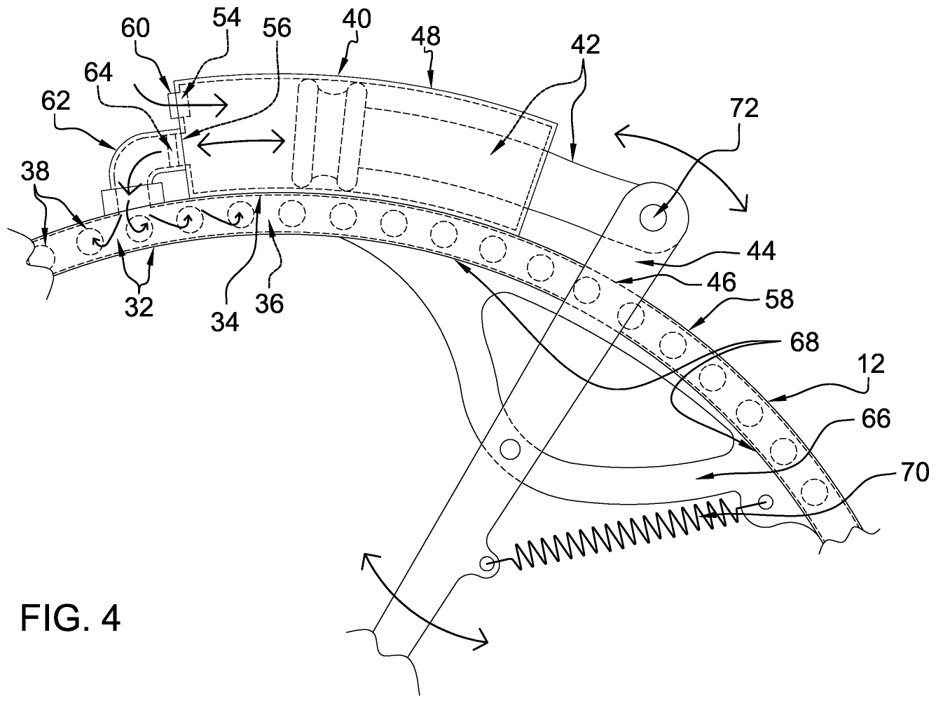

With reference now to the drawings, and in particular to FIGS. 1 through 4 thereof, a new engine assembly embodying the principles and concepts of an embodiment of the disclosure and generally designated by the reference numeral 10 will be described.

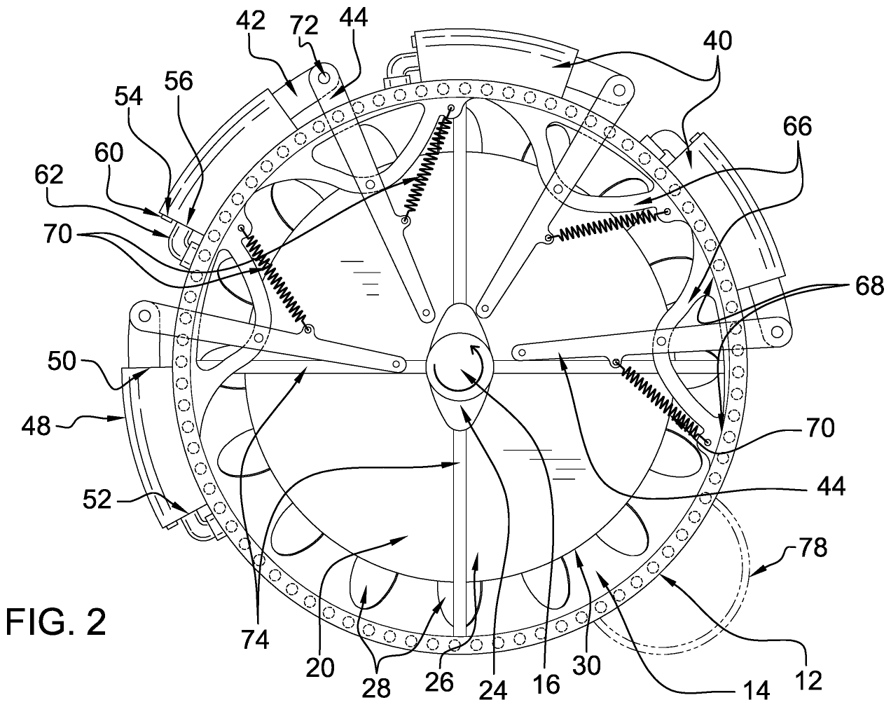

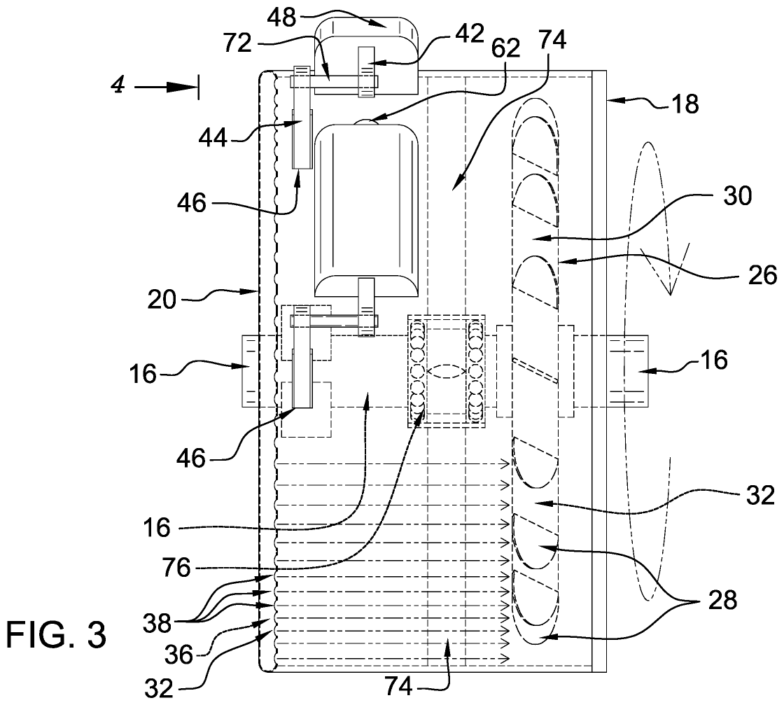

As best illustrated in FIGS. 1 through 4, the air powered engine assembly 10 generally comprises a housing 12, which defines an interior space 14. The housing 12 may be cylindrically shaped, as shown in FIGS. 2 and 3. An axle 16 is rotationally engaged to the housing 12 and extends through a front 18 and rear 20 thereof. A turbine 22 and a cam 24 are engaged to the axle 16 and are positioned in the interior space 14 proximate to the front 18 and the rear 20 of the housing 12, respectively. The turbine 22 comprises a flywheel 26, which has a plurality of blades 28 engaged thereto and extending from a perimeter 30 thereof. The cam 24 is bilobal.

A plate 32 is engaged to the housing 12 and extends around an inner circumference 34 thereof to define a chamber 36 within the interior space 14. The plate 32 has a plurality of apertures 38 positioned therein.

A set of reciprocating compressors 40 is engaged to the housing 12. Each reciprocating compressor 40 is fluidically engaged to the chamber 36 and comprises a piston 42 and an arm 44. The housing 12 has a plurality of cutouts 46 extending therethrough, with each arm 44 extending through an associated cutout 46 into the interior space 14. The arm 44 is rotationally engaged to the piston 42 and the housing 12. The reciprocating compressor 40 is positioned to force air through the apertures 38 such that the air turns the turbine 22 to rotate the axle 16. The cam 24 is rotated to selectively engage alternatingly positioned arms 44 as the axle 16 rotates to actuate associated reciprocating compressors 40.

Each reciprocating compressor 40 also comprises a pipe 48, which has a first end 50 and a second end 52. The first end 50 is open with the piston 42 extending therethrough. The second end 52 is closed and has a first hole 54 and a second hole 56 positioned therein. The pipe 48 may be arcuate and thus complementary to an external circumference 58 of the housing 12, as shown in FIG. 2. The pipe 48 is positioned on the external circumference 58. With the pipe 48 being arcuate, the piston 42 also would be arcuate and thus complementary to the pipe 48.

A first check valve 60 is engaged to the pipe 48 and positioned in the first hole 54. The first check valve 60 is configured to allow entry of air into the pipe 48 through the first hole 54 and to prevent escape of air from the pipe 48 through the first hole 54. A tube 62 is engaged to the pipe 48 and extends from the second hole 56. The tube 62 is engaged to the housing 12 so that the pipe 48 is in fluidic communication with the chamber 36. A second check valve 64 is engaged to and positioned within the tube 62. The second check valve 64 is configured to allow escape of air from the pipe 48 through the tube 62 and to prevent entry of air into the pipe 48 through the second hole 56.

Each of a set of bars 66 has opposed ends 68 engaged to the plate 32 or the housing 12, as shown in FIG. 2. The bar 66 extends arcuately therefrom into the interior space 14. The bar 66 is rotationally engaged to an associated arm 44.

Each of a set of springs 70 is engaged to and extends between a respective arm 44 and an associated bar 66, as shown in FIG. 2. The spring 70 is configured to be tensioned as the respective arm 44 is engaged by the cam 24. The spring 70 is configured to rebound as the cam 24 disengages the arm 44 to actuate the piston 42 to force air through the apertures 38.

Each of a set of pins 72 is rotationally engaged to and positioned between a respective piston 42 and an associated arm 44, as shown in FIG. 3. The pin 72 operationally engages the respective piston 42 to the associated arm 44.

A set of rods 74 is engaged to the housing 12 and positioned in the interior space 14. Each rod extends radially into the interior space 14 from the inner circumference 34 of the housing 12 so that the set of rods 74 is cross shaped. A bearing 76 is engaged to the set of rods 74 distal from the inner circumference 34 of the housing 12. The bearing 76 is operationally engaged to the axle 16 and thus is positioned to transfer axial and radial loads from the axle 16 to the housing 12.

The air powered engine assembly 10 also may comprise a starter housing 78, which is engaged to the housing 12 and which has a starter (not shown) positioned therein. The starter would be operationally engaged to the axle 16 to initiate rotation thereof.

In use, a load, such as a transmission, an air conditioner compressor, or the like, is operationally engaged to the axle 16 proximate to the front 18 of the housing 12.

Rotation of the axle 16 is initiated by the starter, or other means of inducing torque upon the axle 16, such as addition of compressed air through the first check valve 60. The air powered engine assembly 10 provides a more efficient transfer of energy from compressed air to the turbine 22 than would be obtained with an air powered engine lacking the set of reciprocating compressors 40.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An air powered engine assembly comprising:
a housing defining an interior space;
an axle rotationally engaged to the housing and extending through a front and rear thereof;
a turbine engaged the axle and positioned in the housing proximate to the front;
a cam engaged to the axle and positioned in the housing proximate to the rear, the cam being bilobal;
a plate engaged to the housing and extending around an inner circumference thereof defining a chamber, the plate having positioned therein a plurality of apertures; and
a set of reciprocating compressors engaged to the housing such that each reciprocating compressor is fluidically engaged to the chamber, each reciprocating compressor comprising a piston and an arm, the arm being rotationally engaged to the piston and the housing, such that the reciprocating compressor is positioned for forcing air through the apertures such that that the air turns the turbine for rotating the axle, such that the cam is rotated for selectively engaging alternatingly positioned arms as the axle rotates for actuating associated reciprocating compressors.

2. The air powered engine assembly of claim 1, wherein the turbine comprises a flywheel having a plurality of blades engaged thereto and extending from a perimeter thereof.

3. The air powered engine assembly of claim 1, further including each reciprocating compressor comprising:
a pipe having a first end and a second end, the first end being open with the piston extending therethrough, the second end being closed, the second end having a first hole and a second hole positioned therein;
a first check valve engaged to the pipe and positioned in the first hole, wherein the first check valve is configured for allowing entry of air into the pipe through the first hole and for preventing escape of air from the pipe through the first hole;
a tube engaged to the pipe and extending from the second hole, the tube being engaged to the housing such that the pipe is in fluidic communication with the chamber; and
a second check valve engaged to and positioned within the tube, wherein the second check valve is configured for allowing escape of air from the pipe through the tube and for preventing entry of air into the pipe through the second hole.

4. The air powered engine assembly of claim 3, wherein:
the housing is cylindrically shaped;
the pipe is arcuate such that the pipe is complementary to an external circumference of the housing;
the pipe is positioned on the external circumference;
the piston is arcuate such that the piston is complementary to the pipe; and
the housing has a plurality of cutouts extending therethrough, each arm extending through an associated cutout into the interior space.

5. The air powered engine assembly of claim 4, further including:
a set of bars, each bar having opposed ends engaged to the plate or the housing such that the bar extends arcuately therefrom into the interior space, the bar being rotationally engaged to an associated arm; and
a set of springs, each spring being engaged to and extending between a respective arm and an associated bar, wherein the spring is configured for tensioning as the respective arm is engaged by the cam, wherein the spring is configured for rebounding as the cam disengages the arm for actuating the piston for forcing air through the apertures.

6. The air powered engine assembly of claim 1, further including a set of pins, each pin being rotationally engaged to and positioned between a respective piston and an associated arm, such that the pin operationally engages the respective piston to the associated arm.

7. The air powered engine assembly of claim 1, further including:
a set of rods engaged to the housing and positioned in the interior space, each rod extending radially into the interior space from the inner circumference of the housing, such that the set of rods is cross shaped; and
a bearing engaged to the set of rods distal from the inner circumference of the housing, the bearing being operationally engaged to the axle, such that the bearing is positioned for transferring axial and radial loads from the axle to the housing.

8. An air powered engine assembly comprising:
a housing defining an interior space, the housing being cylindrically shaped;
an axle rotationally engaged to the housing and extending through a front and rear thereof;
a turbine engaged the axle and positioned in the housing proximate to the front, the turbine comprising a flywheel having a plurality of blades engaged thereto and extending from a perimeter thereof;
a cam engaged to the axle and positioned in the housing proximate to the rear, the cam being bilobal;
a plate engaged to the housing and extending around an inner circumference thereof defining a chamber, the plate having positioned therein a plurality of apertures;
a set of reciprocating compressors engaged to the housing such that each reciprocating compressor is fluidically engaged to the chamber, each reciprocating compressor comprising:
a piston,
an arm rotationally engaged to the piston and the housing, such that the reciprocating compressor is positioned for forcing air through the apertures such that that the air turns the turbine for rotating the axle, such that the cam is rotated for selectively engaging alternatingly positioned arms as the axle rotates for actuating associated reciprocating compressors,
a pipe having a first end and a second end, the first end being open with the piston extending therethrough, the second end being closed, the second end having a first hole and a second hole positioned therein, the pipe being arcuate such that the pipe is complementary to an external circumference of the housing, the pipe being positioned on the external circumference, the piston being arcuate such that the piston is complementary to the pipe, the housing having a plurality of cutouts extending therethrough, each arm extending through an associated cutout into the interior space,
a first check valve engaged to the pipe and positioned in the first hole, wherein the first check valve is configured for allowing entry of air into the pipe through the first hole and for preventing escape of air from the pipe through the first hole,
a tube engaged to the pipe and extending from the second hole, the tube being engaged to the housing such that the pipe is in fluidic communication with the chamber, and
a second check valve engaged to and positioned within the tube, wherein the second check valve is configured for allowing escape of air from the pipe through the tube and for preventing entry of air into the pipe through the second hole;
a set of bars, each bar having opposed ends engaged to the plate or the housing such that the bar extends arcuately therefrom into the interior space, the bar being rotationally engaged to an associated arm;
a set of springs, each spring being engaged to and extending between a respective arm and an associated bar, wherein the spring is configured for tensioning as the respective arm is engaged by the cam, wherein the spring is configured for rebounding as the cam disengages the arm for actuating the piston for forcing air through the apertures;
a set of pins, each pin being rotationally engaged to and positioned between a respective piston and an associated arm, such that the pin operationally engages the respective piston to the associated arm;
a set of rods engaged to the housing and positioned in the interior space, each rod extending radially into the interior space from the inner circumference of the housing, such that the set of rods is cross shaped; and
a bearing engaged to the set of rods distal from the inner circumference of the housing, the bearing being operationally engaged to the axle, such that the bearing is positioned for transferring axial and radial loads from the axle to the housing.
